(19) United States
(12) Patent Application Publication
(10) Pub. No.: US 2014/0191518 A1
(43) Pub. Date: Jul. 10, 2014

(54) FENCE GATE BRACE

(71) Applicants: Justin Hellander, West Jordan, UT (US); Gregg Niven, Kaysville, UT (US)

(72) Inventors: Justin Hellander, West Jordan, UT (US); Gregg Niven, Kaysville, UT (US)

(21) Appl. No.: 14/078,506

(22) Filed: Nov. 12, 2013

Related U.S. Application Data
(60) Provisional application No. 61/725,331, filed on Nov. 12, 2012.

(51) Int. Cl. E05C 19/08

(52) U.S. Cl. CPC E05C 19/08
USPC 292/281

(57) ABSTRACT

A gate brace is provided which allows the top rail of a fence gate to be attached to the adjacent rail of a fence section or another gate section. The brace keeps the gate from twisting, making the gate stronger and more secure. The brace prevents animals from pushing through the bottom of the gate by twisting the gate, and keeps the gate from flexing due to wind and other forces.

### RELATED APPLICATIONS

The present application claims the benefit of U.S. Provisional Application Ser. No. 61/725,331, filed Nov. 12, 2012, which is expressly incorporated herein in its entirety.

### THE FIELD OF THE INVENTION

The present invention relates to fences. More specifically, the present invention relates to a brace for keeping fence gates closed and for strengthening fence gates.

### BACKGROUND

While modern fencing materials such as vinyl fencing provide a durable and convenient fence material, fence gates are often problematic in that they are flexible. The flexibility of the gate can lead to damage when the gate is pushed against by wind, animals, etc. as the bending of the gate can cause damage to the gate. The flexibility of fence gates also may allow animals to push through the bottom of the gate by twisting the gate. This often causes problems for people trying to keep a dog or other pet confined to a yard.

### BRIEF DESCRIPTION OF THE DRAWINGS

Various examples of the present invention are shown and described in reference to the numbered drawings wherein:

FIG. 1 shows a perspective view of a gate brace;

FIG. 2 shows a side view of the brace of FIG. 1;

FIG. 3 shows a top view of the brace of FIG. 1;

FIG. 4 shows an end view of the brace of FIG. 1;

FIG. 5 shows a perspective view of a gate brace;

FIG. 6 shows a side view of the brace of FIG. 5;

FIG. 7 shows a top view of the brace of FIG. 5;

FIG. 8 shows an end view of the brace of FIG. 5;

FIG. 9 shows a side view of the brace of FIG. 1; and

FIG. 10 shows another side view of the brace of FIG. 1.

It will be appreciated that the drawings are illustrative and not limiting of the scope of the invention which is defined by the appended claims. The examples shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every example need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

A fence gate brace is provided to secure and strengthen a fence gate while the gate is closed. Fence gates often include a side with hinges connecting the gate to another portion of the fence and a free side which may swing open. The free side of the gate typically includes a single latch to hold the gate closed. The use of a single latch, while allowing the gate to be opened more conveniently, allows the gate to twist. This twisting allows an opening past the gate to be formed even if the gate remains securely closed. The gate brace may be placed across the top of the gate, bridging the latch side of the gate (the side opposite the gate hinges) and an adjacent fence post or gate side. The brace may be used to connect the latch side of the gate to an adjacent section of fence or to another section of the gate and assists to keep the gate aligned with the fence. The brace may be used to prevent the top of the gate from moving out of plane with the gate/fence. This keeps the gate from twisting due to wind or other forces. The brace keeps animals from pushing against the bottom of the gate and flexing the gate sufficiently to push through the gate. The gate brace makes it easier for person to keep an animal contained by the fence, and helps to prevents damage to the gate by wind or other forces.

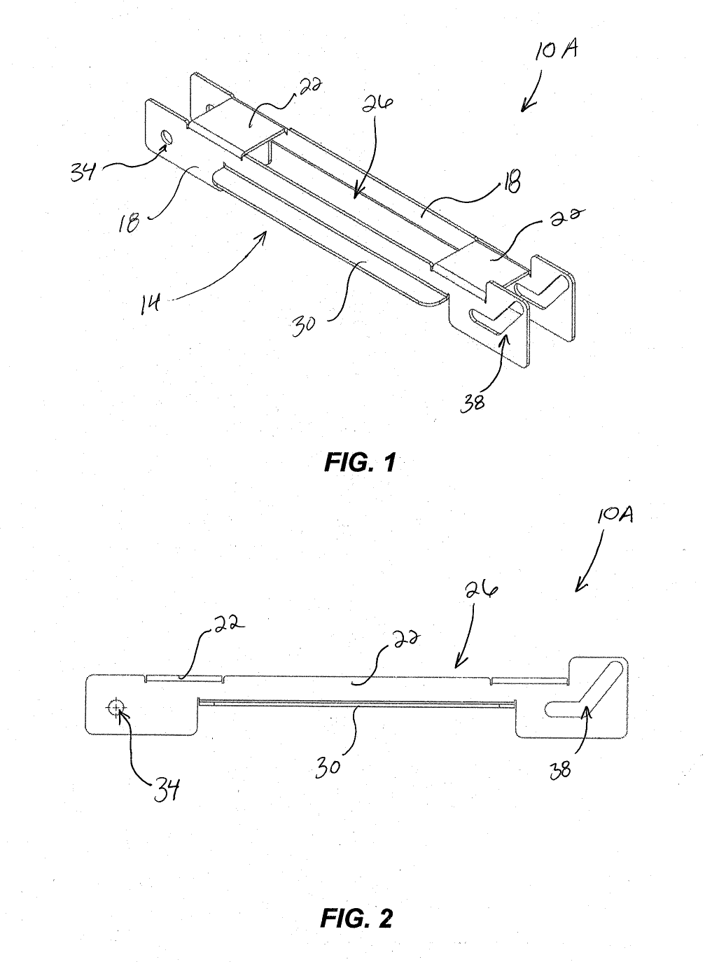

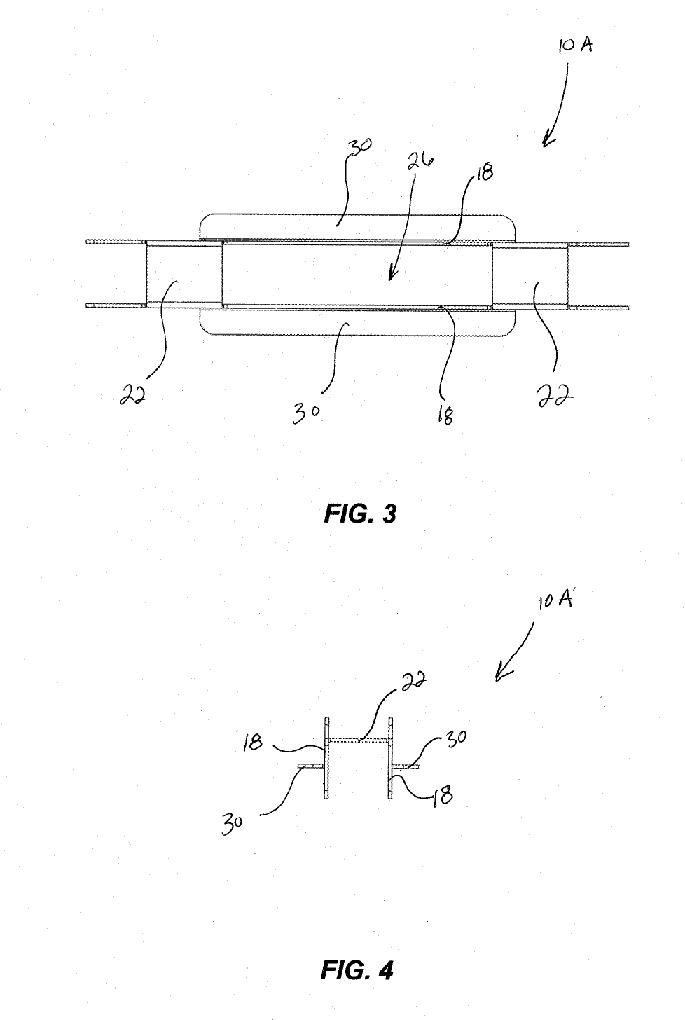

Referring now to FIGS. 1 through 4, a gate brace 10A is shown. The brace 10A generally forms a channel 14 and includes two sides 18 which are connected by a top 22. The top 22 may have an opening 26 formed therein. The sides 18 may be formed with laterally extending flanges 30. The flanges 30 strengthen the sides 18 and add stability to the brace 10A. The flanges 30 extend beyond the opening 26, overlapping the top portions 22. The sides 18 are formed with a hole 34 at one end and a channel 38 at the other end. The hole 34 may be used to lock the brace in a closed position when installed on a fence gate, and the channel 38 may interact with a pin to form a pivot, allowing the gate brace 10A to be moved between opened and closed positions. The brace 10 may be attached to a gate via a pin which passes through the channel 38 and through the gate, allowing the brace to be moved as the pin slides and rotates within the channel 38.

The channel 38 may be elongate and may be formed in an L or V shape. As shown, the channel 38 has a generally horizontal portion extending towards the hole 34 and a diagonal portion extending upwards away from the hole 34 at about a 45 degree angle. The horizontal portion of the channel 38 may extend partially beneath the top 22 and may extend beyond the top 22. Such a configuration may lock the brace 10 against a gate when the brace is slid so that the pin is located beneath the top 22 and allowing the brace to pivot up away from the gate (about the pin) when the pin is located to the right side of the brace where the pin is not underneath the top 22.

The configuration of the brace 10 provides strength. The longitudinally overlapping top 22, sides 18, and flanges 30 strengthen the brace 10 against bending and twisting and provide strength when the brace 10 is in use. Additionally, the design allows for easy fabrication. The brace 10 may be water jet, laser, or plasma cut from sheet metal and bent into the configuration shown. The brace 10 does not require welding and only requires 4 bends which may be performed on an automatic bending brake.

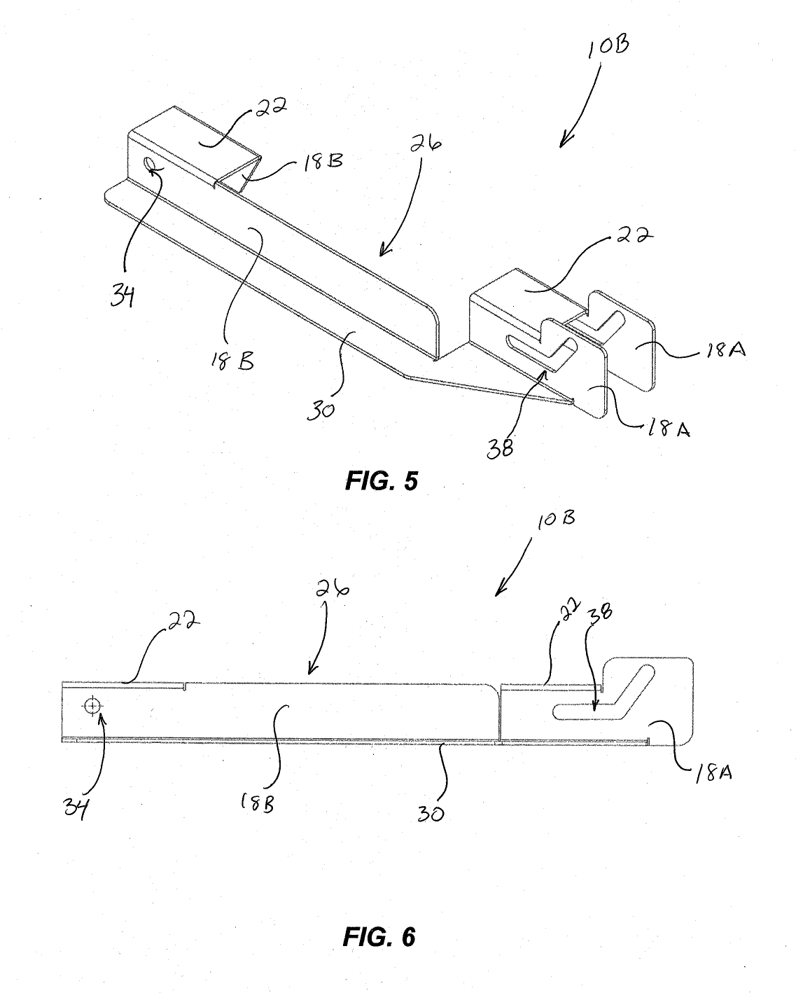

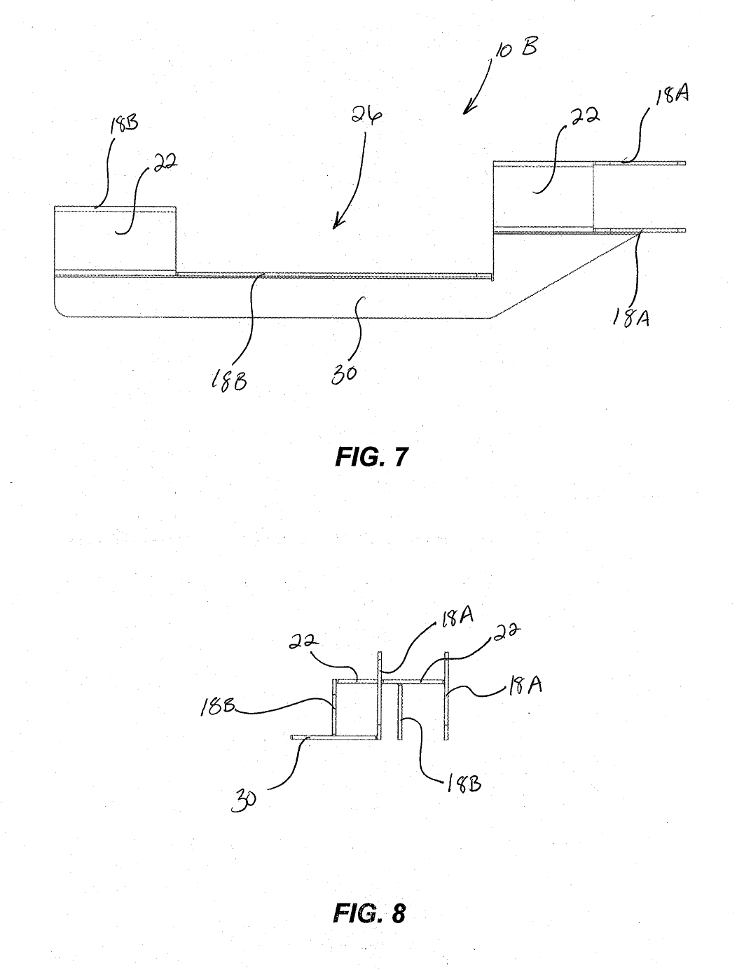

Referring to FIGS. 5 through 8, another gate brace 10B is shown. Although structurally similar, the gate brace of FIGS. 5 through 8 is shaped differently than that of FIGS. 1 through 4. The brace 10A may often be used with a double gate that has two opposed gate sections while the brace 10B may often be used with a single gate. The brace 10B includes sides 18, a top 22, and forms a channel 14. The brace 10B includes a channel 38 and hole 34 used to operate and secure the brace.

The brace 10B primarily differs from the brace 10A in that the opening 26 is enlarged to accommodate a larger fence post as well as a gate upright member. Additionally, the sides 18 may be separated into a first side portion 18A having the pivot channel 38 and a second side portion 18B having the lock hole 34. If desired, one side 18 may be open such that the opening 26 is not bounded by that side. This may be desirable to accommodate different sizes of fence posts or gate uprights without unnecessarily complicating the brace 10B.

Due to the various brands and styles of gates and fences, it may be necessary to provide different configurations of braces 10. For example, many vinyl fences have an enlarged post which is about 5 inches thick and rails which are about 2 inches thick. Vinyl gates may have vertical posts which are about as thick as the rails; about 2 inches thick. Vinyl gates may also have vertical posts which are thicker than the rails and which may be about 3.5 or 4 inches thick. The gate brace 10A may secure two opposed gate sections which have vertical posts about the same thickness as the gate horizontal rails. The gate brace 10B may secure a gate section with a post about the same thickness as the gate rail to a larger fence post and rail. A gate brace similar to brace 10B but having the side portion 18B also offset from the edge of the opening 26 similar to side portion 18A may be used to secure a gate with a vertical post which is larger than the horizontal rails to a larger fence post and fence rail.

The gate brace 10A, 10B is designed such that it may be cut from a flat piece of metal, such as a sheet of steel, aluminum, or stainless steel, and may be bent to form the completed shape shown. The design minimizes the steps which are necessary in manufacturing the brace 10A, and allows for easy production. By way of example, the brace 10A, 10B may be laser cut, bent, and painted or powder coated. Labor intensive steps such as welding are not required.

Typically, the gate brace 10A, 10B will be installed to extend across adjacent halves of a gate or across a gate and an adjacent section of fence. As such, the opening 26 will typically be placed over the lateral upright members (posts) of the gate frames, or over a gate upright and a fence post. The pivot channel 38 may be attached to an upper fence rail or to the upper rail of a gate with a pivot pin 58, allowing the gate brace 10A, 10B to be moved between a closed and an open position. The lock hole 34 may be pinned to an upper gate rail or upper fence rail with a removable pin or bolt to keep the brace 10A, 10B in a closed position if desired.

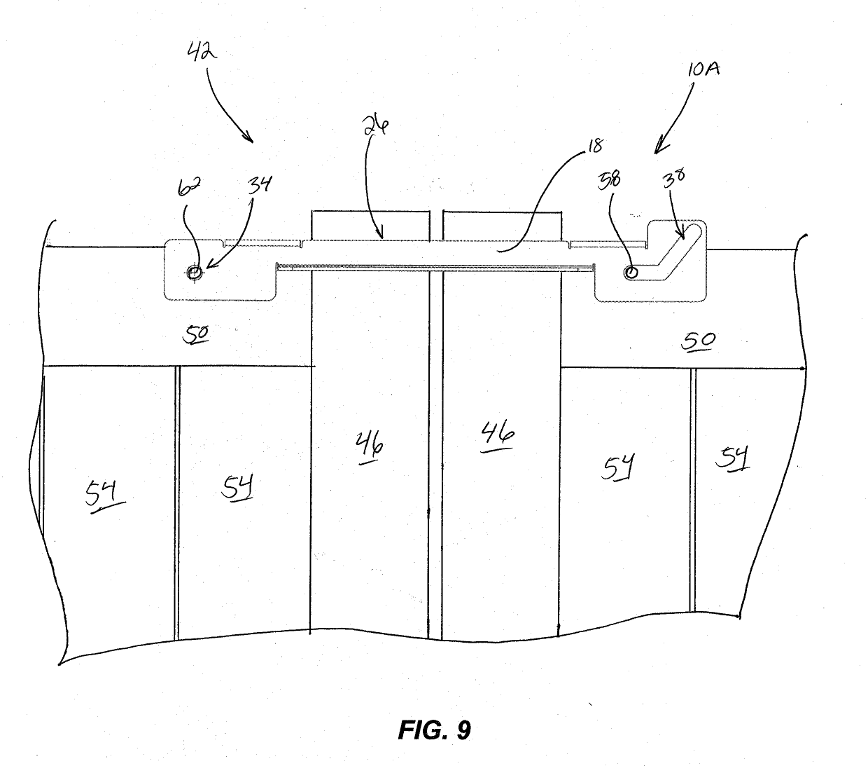

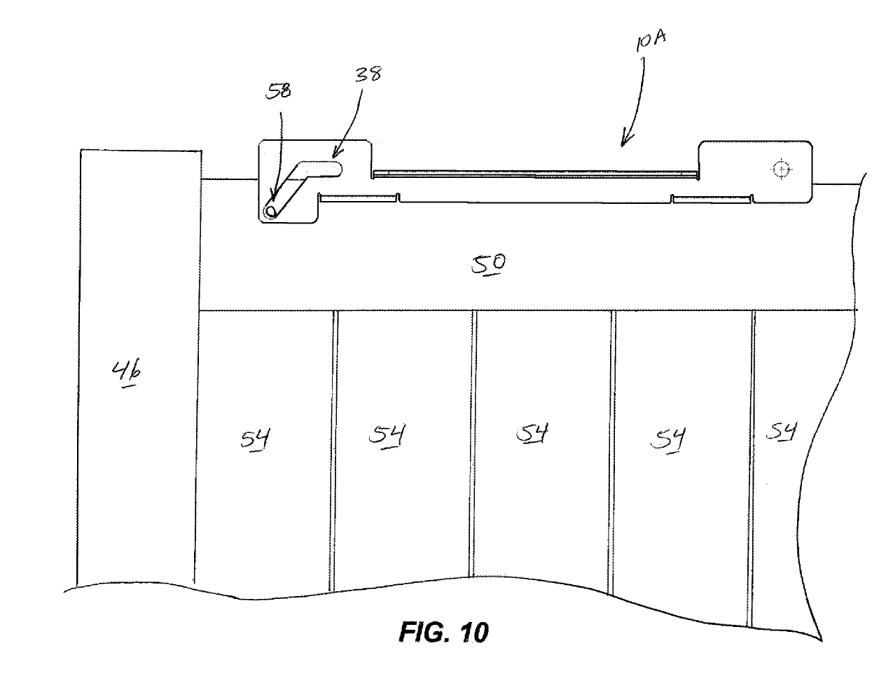

FIG. 9 shows gate brace 10A installed onto a gate 42. The gate 42 shown is a double gate and has two gate halves. Each gate half includes an upright member 46, an upper rail 50, and slats 54. A gate brace 10 installed onto a gate and fence section would be similarly installed and would function in a similar manner. The pivot channel 38 is attached to an upper rail 50 with a pin or bolt 58. The pivot channel allows the brace 10 to be pivoted over the upright members 46 and placed over the opposing upper rail 50, where a pin 62 (or bolt, lock, etc.) may be placed through the hole 34 to secure the brace 10 to the upper rail. The upright members 46 may pass through the opening 26.

The gate brace 10 secures the top of the gate (either securing two opposing gate halves together or securing a gate to a section of fence). It will be appreciated that the gate brace 10A, 10B may be attached such that the pivot channel 38 is attached to a gate or to a section of fence. As the gate latch is usually in the middle of the gate, the brace 10A, 10B keeps the gate from twisting vertically around the gate latch when pushed against. This keeps the gate closed when animals try to push through the bottom of the gate, when wind pushes against the gate, etc.

When the gate brace 10 is placed in the position shown in FIG. 9, the pivot pin 58 is located beneath the top 22 and the top 22 would prevent the brace 10 from fully pivoting to the right to allow the gate to open. As such, the brace 10 used alone provides a degree of security in holding the gate closed against wind or animals. The gate brace 10 thus is useful in securing the gate without locking the brace 10 to the gate with an additional pin 62 and requiring use of a key or performing additional steps to open the gate.

FIG. 10 shows the gate brace 10A in an open position. To open the gate brace 10, the pin or lock 62, if used, must be removed from the gate brace hole 34. The gate brace 10 may then be slid to the left so that the pivot pin 58 is not located beneath the top 22 of the gate brace 10. Typically, the pin 58 will be located adjacent to the upwardly extending portion of the channel 38. The brace 10 may then be pivoted upwardly around the pin 58 to the position shown. As is seen, the upwardly extending portion of the pivot channel 38 allows the brace 10 to move upwardly relative to the rail 50 as it is pivoted. This places the pivot pin 58 in the upper, distal portion of the channel 38 and allows the brace 10 to lay flat against the rail 50 where it is not unsightly and does not present an obstruction to normal use of the gate. In this position, persons walking through the gate will not accidentally walk into the brace 10.

The gate brace 10 provides a convenient manner for strengthening a fence gate against twisting and bending when force is applied to the gate. This strengthens the gate against damage during storms or when on object collides with the gate. This also prevents an opening past the gate from being formed when the gate is twisted and keeps animals from passing through the gate.

There is thus disclosed an improved gate brace. It will be appreciated that numerous changes may be made to the present invention without departing from the scope of the claims.

1. A gate brace attachable to the top of a vinyl fence gate to secure the gate in a closed position comprising:
a body defining a channel to receive a gate upper rail therein;
an opening in the body to allow a gate upright member to pass therethrough;
a pivot channel formed in a first end of the body; the pivot channel being attachable to a gate upper rail or a fence upper rail to allow the gate brace to pivot about the pivot channel;
a lock hole formed in a second end of the body, the lock hole being attachable to a gate upper rail or a fence upper rail to secure the gate brace in a closed position; and
wherein the gate brace is movable into a closed position wherein the gate brace extends along the gate upper rail and over the gate upright member to attach the gate to an adjacent gate rail or fence rail to thereby prevent the gate from opening.

2. The gate brace of claim 1, wherein the brace is cut from a piece of flat metal and bent to shape.

3. The gate brace of claim 1, wherein the gate brace more specifically comprises a top portion, an opening formed in the top portion to allow a gate upright member to pass therethrough, two sides extending downwardly from the top portion, and a channel formed between the sides and the top portion to receive a gate upper rail therein.

4. The gate brace of claim 1, wherein the gate brace is installed onto a gate, wherein the pivot channel is attached to an upper rail to allow the gate brace to pivot between an open position where the gate brace does not prevent the gate from being opened and a closed position where the gate brace channel is disposed over an upper rail of the gate and the gate brace prevents the gate from being opened.

5. The gate brace of claim 4, wherein the lock hole is attachable to an upper rail to secure the gate brace into the closed position.

6. The gate brace of claim 1, wherein the opening receives a gate upright member and a fence post therethrough to secure a gate to the fence post.

7. The gate brace of claim 1, wherein the opening receives two gate upright members therethrough to secure two adjacent halves of a gate together.

8. A fence gate brace for securing a fence gate in a closed position comprising:
a top portion;
an opening formed in the top portion to allow a gate upright member to pass therethrough;
two sides extending downwardly from the top portion;
a channel formed between the two sides and the top portion to receive a gate upper rail therein; and
wherein a first end of the gate brace is pivotably attached to a gate upper rail or a fence upper rail to allow the gate brace to pivot about the first end; and
wherein the gate brace is pivotable about the first end such that the channel is disposed over a gate upper rail and a gate upright member is received through the opening whereby the gate brace prevents the gate from opening.

9. The fence gate brace of claim 8, wherein the first end of the gate brace comprises a pivot opening formed therein and wherein the gate brace further comprises a pivot pin extending through the pivot opening and securing the first end of the gate brace to an upper rail.

10. The fence gate brace of claim 8, wherein a second end of the gate brace comprises a lock hole formed therein, and wherein the lock hole is attachable to a gate upper rail or a fence upper rail to secure the gate brace in a closed position and prevent opening of the gate.

11. The fence gate brace of claim 8, wherein the opening receives a gate upright member and a fence post therethrough and wherein the channel receives a gate upper rail and a fence upper rail therein to secure a gate to the fence post and prevent the gate from opening.

12. The fence gate brace of claim 8, wherein the opening receives two gate upright members therethrough and wherein the channel receives two gate upper rails therein to secure two adjacent halves of a gate together and prevent the gate from opening.

13. A fence gate brace for securing a fence gate in a closed position comprising:
a body portion having a top and having a side extending downwardly from the top;
an opening formed in a top of the body portion to allow a gate upright member to pass therethrough;
wherein a first end of the gate brace is pivotably attached to a gate upper rail or a fence upper rail to allow the gate brace to pivot about the first end; and
wherein the gate brace is pivotable about the first end between an open position wherein the gate brace does not prevent opening of the gate and a closed position wherein the body portion is disposed over a gate upper rail and a gate upright member is received through the opening such that the gate brace prevents the gate from opening.

14. The fence gate brace of claim 13, wherein the gate brace more specifically comprises:
two sides extending downwardly from the top portion; and
a channel formed between the two sides and the top portion to receive a gate upper rail therein.

15. The fence gate brace of claim 13, wherein the first end of the gate brace comprises a pivot opening formed therein and wherein the gate brace further comprises a pivot pin extending through the pivot opening and securing the first end of the gate brace to an upper rail.

16. The fence gate brace of claim 13, wherein a second end of the gate brace comprises a lock hole formed therein, and wherein the lock hole is attachable to a gate upper rail or a fence upper rail to secure the gate brace in a closed position and prevent opening of the gate.

17. The fence gate brace of claim 13, wherein the opening receives a gate upright member and a fence post therethrough and wherein the channel receives a gate upper rail and a fence upper rail therein to secure a gate to the fence post and prevent the gate from opening.

18. The fence gate brace of claim 13, wherein the opening receives two gate upright members therethrough and wherein the channel receives two gate upper rails therein to secure two adjacent halves of a gate together and prevent the gate from opening.
